(19) United States
(12) Patent Application Publication
(10) Pub. No.: US 2009/0243948 A1
(43) Pub. Date: Oct. 1, 2009

(54) MODULAR UNIT FOR A RADAR ANTENNA ARRAY HAVING AN INTEGRATED HF CHIP

(76) Inventors: Ewald Schmidt, Ludwigsburg (DE); Hans Irion, Winnenden (DE); Juergen Hasch, Stuttgart (DE); Hans-Oliver Ruoss, Stuttgart (DE)

Correspondence Address: KENYON & KENYON LLP, ONE BROADWAY, NEW YORK, NY, 10004, US

(21) Appl. No.: 12/088,986

(22) PCT Filed: Nov. 9, 2006
(86) PCT No.: PCT/EP2006/068271

§ 371 Date: Jul. 24, 2008

(30) Foreign Application Priority Data
Nov. 29, 2005 (DE) 10 2005 056754.1
Feb. 27, 2006 (DE) 10 2006 009012.8

(51) Int. Cl. H01Q 15/08; H01Q 15/02; H01Q 19/06

(52) U.S. Cl. 343/753; 343/911 R; 343/909; 29/428

(57) ABSTRACT

A modular unit for a radar antenna array having an integrated HF chip, at least one antenna element that has a microwave structure, a focusing element situated in the ray path of the radar antenna array upstream of the at least one antenna element, using which an amplified illumination of the HF chip is achieved, has, in particular, an addition-to-structure device, using which focusing elements of different antenna characteristics can be attached to the modular unit. The addition-to-structure device is preferably formed by fasteners such as clamping devices and plug-in devices. Positioning devices can additionally be provided, using which the focusing element can be attached to the modular unit with precision.

### FIELD OF THE INVENTION

The present invention relates to a modular unit and a focusing element for a radar antenna array as well as to a corresponding radar antenna array. The present invention also relates to a method for manufacturing such a modular unit.

### BACKGROUND INFORMATION

A radar antenna array having an HF chip is described in European Patent No. EP 1 121 726 B1. The HF chip has send/receive elements in the form of a conventional microwave structure. The array also includes a so-called “polyrod”, i.e., a dielectric radiation body or prefocusing body (focusing element) disposed in front of each antenna element in the beam path of the antenna array, for example, a rod radiator, using which a better illumination of a dielectric lens (resonator) is achieved and thus a prefocusing of the radar beam.

A flawless function of such a focusing element is ensured only when the latter is accurately positioned with respect to the HP chip, for even slight deviations from the ideal installation position cause a blooming of the lens, an error angle of the radiated wave or an increased magnetic coupling between adjacent polyrods, in the case of multibeam systems. In the radar antenna array described there, the distance between the surface of the microwave conductive pattern and the lower side of the polyrod can be freely set using a spacer in a range between 0 and 0.2 mm.

One may mount the HF chip, having an integrated antenna, as a usual SMT printed-circuit board on a punched grid, contact the chip via bonding wires to the terminals and subsequently embed the chip thus mounted using a sealing material. As is conventional, the SMT mentioned (surface mount technology) makes possible direct solder connection of component parts to a printed-circuit board (PCB). In this component, however there is no rod radiator present that has a resonator.

### SUMMARY

It may be desirable to make available a modular unit into which a previously described HF chip is able to be integrated, in which the great requirements on the position accuracy, that were named at the outset, are satisfied. At the same time, as simple as possible a mounting should be made possible on a cost-effectively printed printed-circuit board, for instance, using the SMT technology mentioned, or the contact hole technology that is also familiar to one skilled in the art.

The example modular unit according to the present invention includes a mounting fixture or a mounting interface, using which focusing elements of different antenna characteristics or radiation patterns can be mounted in a simple manner on the modular unit, for instance, clipped onto the modular unit or pinned on. This has the advantage that only relatively late in the assembly line the respective application of such a radar antenna array can be established, that is, with which focusing element the modular unit has to be equipped for the specific radar antenna application.

The mounting fixture mentioned includes, in turn, positioning devices and clipping devices using which, for example, a focusing element developed as a rod radiator is able to be attached to a focusing element of any desired beam characteristic which has positioning elements and clipping elements that match the modular unit.

Thus, according to the present invention, an example radar antenna array is proposed having a modular unit that is universal and can be equipped with one or more radiation sources of different radiation patterns that can be produced using simple and cost-effective printed-circuit assembly, namely, in a similar way as with the SMT components described at the outset.

The HF chip having an integrated antenna patch preferably has contact surfaces for flip chip bumps, using which the HF chip can be mounted very simply onto the modular unit. The flip chip bumps, in this context, can be applied either to the chip or the chip assembly conductive element.

According to a first example embodiment, the modular unit is produced from a 2½ MID-SMT plastic part having a “flipped-in” HF chip while using a heat sink and a molding compound. An alternative production method of the modular unit according to the present invention is represented by flip-chip technique of the HF chip on a flexible printed-circuit board, which is conventional. The printed-circuit board having the HF chip is cemented in place in an appropriate plastic part, in this instance, using a flat surface or a surface curved in only one direction, and provided with a contact. A heat sink is cemented in place in appropriately developed recesses of the plastic part in such a way that a heat contact is formed on the rear side of the HF chip. The modular unit is finally completed using a molding compound.

According to a second example embodiment, the modular unit formed from an HF chip and a focusing element (preferably a rod radiator) is fastened to a carrier, preferably plugged into the carrier, in such a way that the rear side of the HF chip forms a heat contact with the carrier. In this context, the heat contact can even be improved by appropriate adhesion or soldering. The HF chip is fastened, in turn, to the appropriately designed rod radiator, namely, in this instance, preferably clipped into the rod radiator. At the same time, a cost-effective NF printed-circuit board is situated on the carrier which is pierced in the area mentioned. The required electrical contacting of the HF chip contacts to the printed-circuit board is then performed using the usual NF wire bonding. This area is then encapsulated in such a way that the first available free space is filled because of the desired distance between the HF chip and the resonator on the rod radiator. In this case there is no SMT component, and the radiation pattern is established right from the start by the rod radiator.

In this method, the electrical contacts of the HF chip are not covered by the focusing elements (preferably rod radiators), and also no galvanic connections are created between the HF chip and the rod radiator.

According to a third preferred design approach, the untreated HF chip is fastened by being positioned on a carrier having a platform, preferably adhered to the carrier or soldered onto it. The carrier also acts as a heat sink, in this instance. The rod radiator having a resonator is then positioned into the carrier, above the HF chip, and plugged in in such a way that the rod radiator and its spacers are supported on ground pads of the HF chip. The chip is contacted to the printed-circuit board using the usual bonding wires and is then encapsulated. The contacting can be carried out before or after the assembly of the rod radiator. There is no HF module in this case, but an HF unit is formed within an electronic circuit, using standard technologies.

A modular unit according to the present invention can be operated in a preferred frequency range of Ca. 70-140 GHz.

### BRIEF DESCRIPTION OF THE DRAWINGS

The present invention is described in more detail below, with reference to the figures, and on the basis of exemplary embodiments from which further features and advantages of the present invention are derived. In the figures, identical or functionally identical features are referenced using identical reference numerals.

FIG. 1a shows a slantwise top view from above onto an already produced modular unit according to the present invention.

FIG. 1b shows a sectional view of the modular unit shown in FIG. 1a.

FIGS. 2a, b also show slantwise top views onto a modular unit according to the present invention before (a) the production and assembly according to the present invention, namely in an exploded illustration, and after (b) the assembly according to the present invention, including a mounted rod radiator (focusing element).

FIGS. 3a-c also show slantwise top views onto a modular unit according to the present invention having three different rod radiators (a-c) before (top) and after (bottom) their installation into the modular unit.

FIG. 4 shows a slantwise view from below onto a second exemplary embodiment (see second preferred design approach that was mentioned) of a focusing element according to the present invention having positioning supports and clipping devices for the installation of an HF chip.

FIGS. 5a-c shows three different views of a focusing element according to the present invention according to the second exemplary embodiment (see second preferred design approach that was mentioned) having an inserted HF chip from above (a), having an inserted HF chip and adhesive layer from below (b) and a focusing element mounted on a carrier part according to the present invention using a platform and being already electrically contacted, from above (c).

FIGS. 6a, b show two sectional views (a, b) of a ready mounted and already encapsulated focusing element according to the second exemplary embodiment (see second preferred design approach that was mentioned).

FIGS. 7a, b show an exemplary embodiment of the focusing element according to the present invention according to a third exemplary embodiment (see third preferred design approach that was mentioned) having a resonator (a) printed on a foil and to be glued in, and a resonator (b) printed directly onto the focusing element.

### DETAILED DESCRIPTION OF EXAMPLE EMBODIMENTS

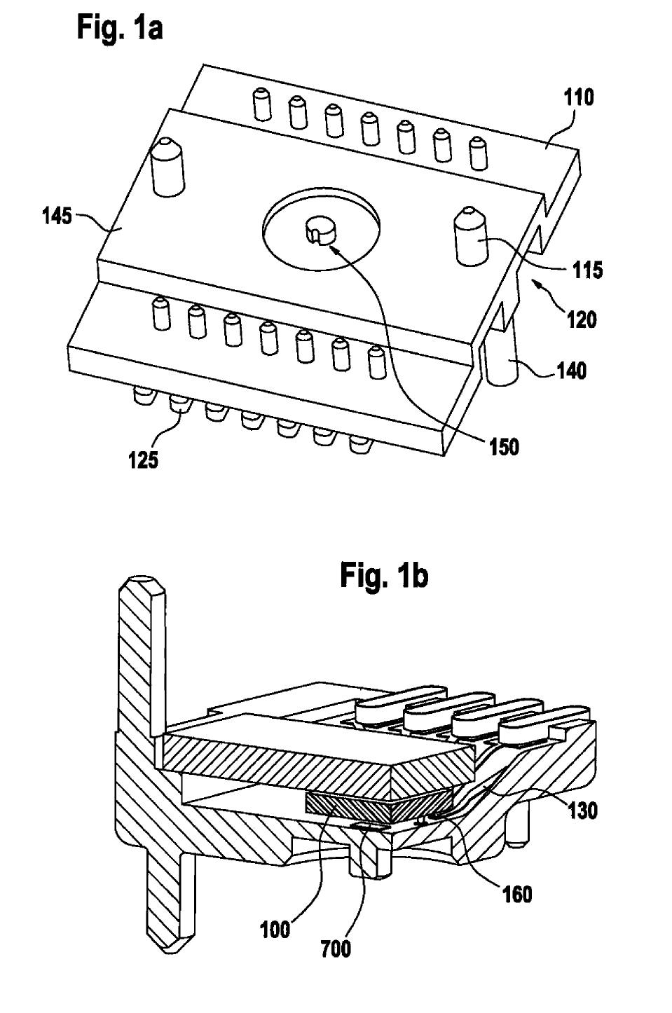

The modular unit presently produced for printed-circuit board technology, shown in FIGS. 1a and 1b as well as 2a and 2b in various views, includes a high frequency (HF) chip 100 having an integrated antenna patch not seen in the figure, and having flip-chip bumps 160 that are partly visible in sectional drawing FIG. 1b, as well as having a heat sink 105 formed of a punched metal part.

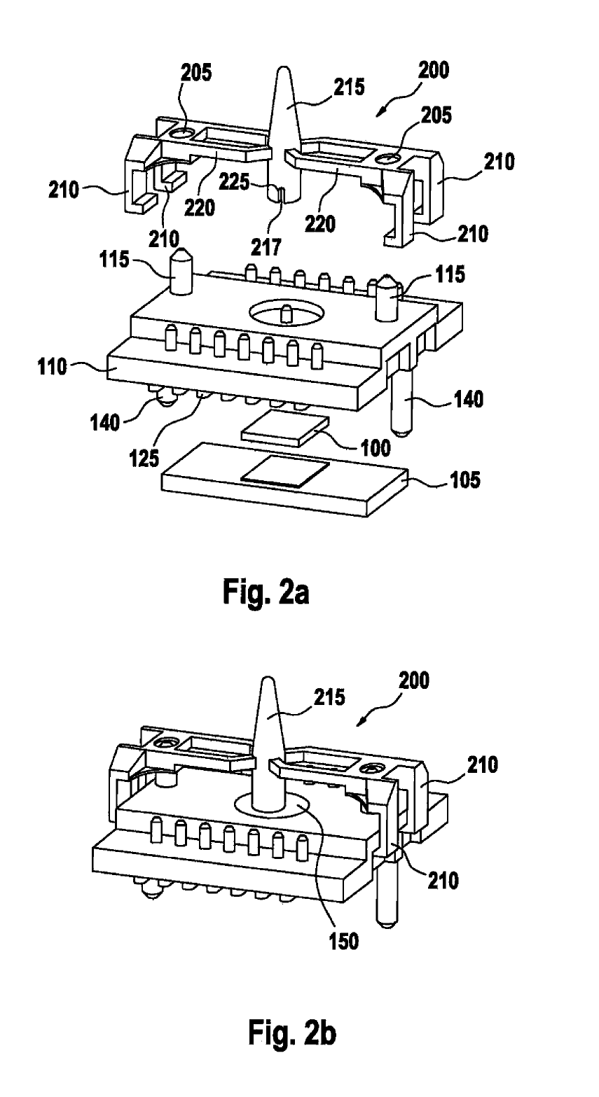

HF chip 100 and a heat sink 105 are situated on a base 110 (called “carrier part” below) that is produced from a plastic injection molded part made of PEI (=polyeterimide), and which has specified position devices 115 and clipping devices 120 for a focusing element, not shown here, (which in the present exemplary embodiment is a rod radiator—see reference numeral ‘200’ in FIGS. 2a and 2b).

Position devices 115 and clipping devices 120 are mechanically connected, using inserted contact pins 125, to conductive patterns 130 that are made of 2½ mold injected devices (=MID). All the functional elements are situated interspersed with one another in a area-saving and space-saving manner. The rod radiator shown in FIG. 2 has, in particular, a focusing element 200 of a predefined radiation pattern, made of a dielectric material, having positioning devices 205 and clipping devices 210 that match base 110. Focusing element 200 is made up of a cone-shaped radiation element 215 having a “radiator foot” 217 situated in the direction towards HF chip 100. Radiation element 215 is situated elastically on two double crosspieces 220 that run towards the center. In FIG. 2a one may also see casting channel 225, situated in the radiator foot, for encapsulation in a vacuum.

The HF chip 100 having an antenna patch already integrated in a conventional manner, and the flip-chip bumps mentioned is first installed in carrier part 110 of the modular unit (“flipped in”) and is therefore not visible in FIG. 1a. The flip-chip technique generally has the necessary good positioning tolerance. Besides the contact-free HF patch transition, all lower-frequency (LF) contacts to contact pins 125 of HF chip 100 are also produced in complete form. In this context, on the level of the conductor of carrier part 110, namely above the antenna patch of the HF chip, a corresponding resonator patch is coproduced, and without additional cost.

One of the contact surfaces between heat sink 105 or the back side of HF chip 100 is coated either with soldering paste or adhesive, for instance, using a conventional dispense(r) stamp printing technique. Heat sink 105 is inserted into carrier part 110 that is provided with the appropriate recesses and HF chip 100 and is adhered together or soldered with the back side of HF chip 100.

According to the present exemplary embodiment, focusing element 200 is fastened to carrier part 110 in such a way that, for example, the clip connection shown in FIG. 2b is improved, using clipping devices 210 with respect to their x,y positioning accuracy, in that clipping devices 210 are made up of one functioning part situated on movable springs 220.

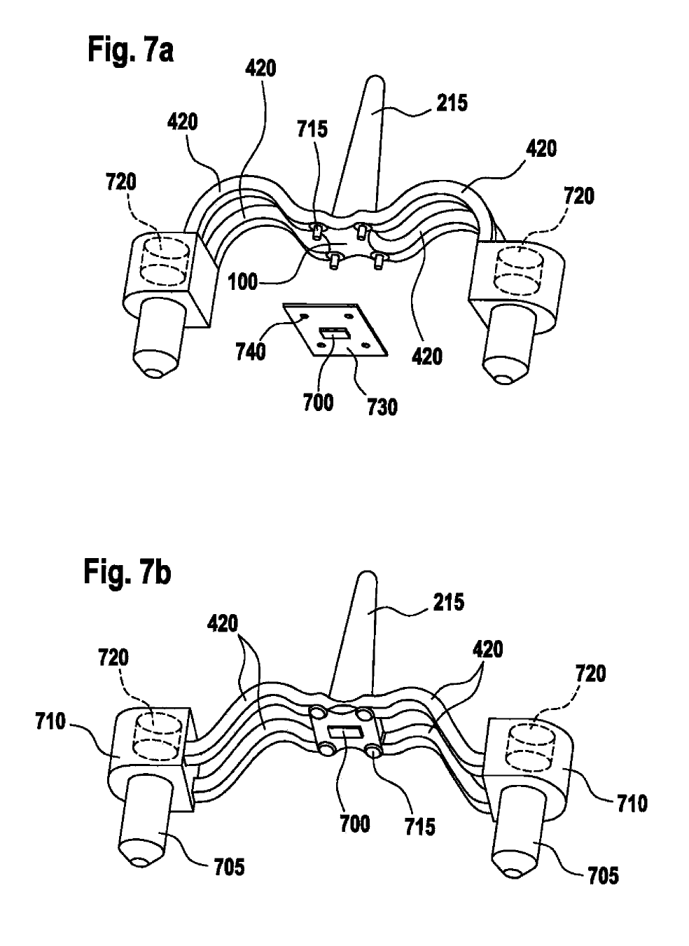

The present assembly (FIG. 1a) is subsequently encapsulated from the rear side, as much as possible free from shrink holes, using sealing material 135, preferably under the vacuum conditions that were mentioned. The sealing compounds that come into consideration are, for instance, silicone gel or epoxy resin (which is harder) since the basically existing damping effect of sealing compound 135 in the very small gap of ca. 100 μm between HF chip 100 and the resonator (see, for instance, FIG. 7a, reference numeral ‘700’) shows no measurable disadvantage. FIG. 1b shows the modular unit without sealing compound 135, for the purpose of simplification, and without the heat connection between HF chip 100 and heat sink 105.

Alternatively, the modular unit can be plugged in from the lower side of a printed-circuit board 800 via corresponding apertures in printed-circuit board 800, namely using conventional pin-hole connections, and only after that, can be soldered together with the other electronic components. The rod radiator situated on a plastic part is plugged onto the positioning elements of the modular unit and “clipped in”.

Finally, a specified quantity of additional encapsulating material (not shown here) is put into an encapsulating pot and an encapsulating channel 150 of carrier part 110 at which radiator foot 217 of radiation element 215 is situated essentially in a centrical position (FIG. 2b). This additional sealing compound also rises in the foot of the radiation element on the appropriate channels, so that no air gap forms between carrier part 110 and radiation element 215.

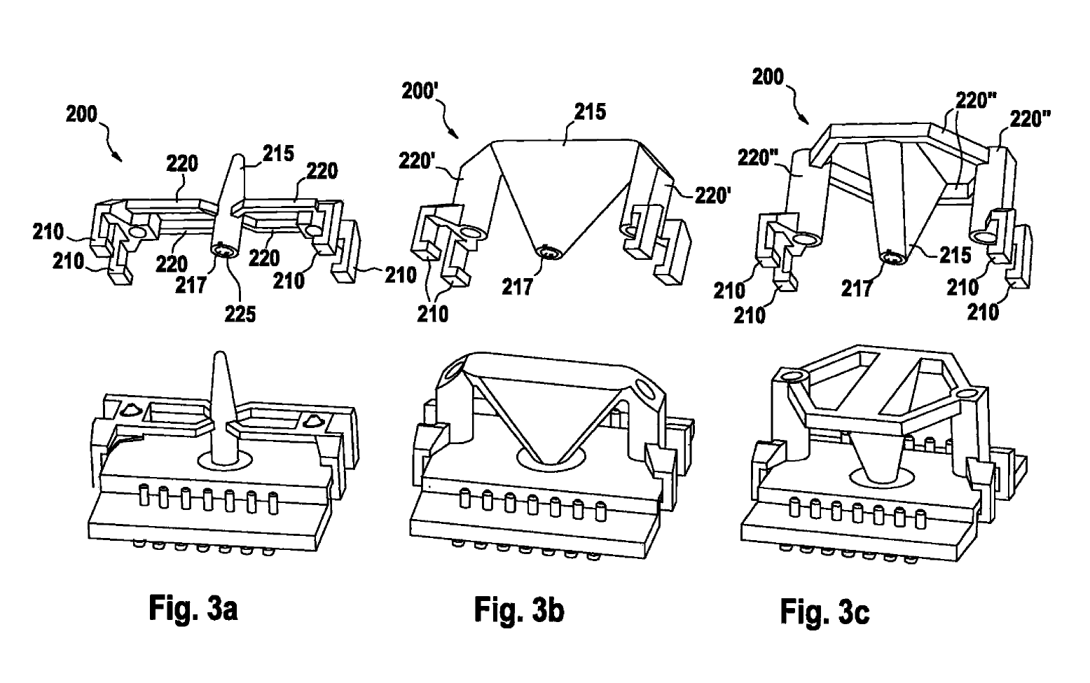

The radiation pattern of focusing element 200 can be specified at will. Examples for possible different embodiments of focusing element 200 or the preferred cone-shaped radiation element 215 are shown in FIGS. 3a-3c. The parts respectively forming the upper parts of FIGS. 3a-3c show the respective focusing elements 200 before their incorporation into carrier part 110, and the respective lower parts show the respective situation of focusing elements after their incorporation into carrier part 110. Focusing elements 200 are preferably and advantageously clipped in on carrier part 110 using clipping devices 210, after the printed-circuit board assembly of carrier part 110, and radiator foot 217 is subsequently encapsulated in encapsulating pot 150. Alternatively, the installation can take place before the printed-circuit board assembly of carrier part 110.

The specific embodiments of focusing element 200 shown in FIGS. 3a-3c generally differ in the respectively different design of cone-shaped radiator element 215 and of respective radiator foot 217. FIG. 3a shows focusing element 200 having a radiator foot 217 that is respectively already encapsulated, whereas FIGS. 3b and 3c reflect focusing element 200, respectively without sealing compound.

Focusing element 200 shown in FIG. 3a corresponds to the embodiment shown in FIGS. 2a and 2b. In the case of focusing element 200 shown in FIG. 3b, the conic curve of conic-shaped radiation element 215 is opposite to the one shown in FIG. 3a. As can be seen better in the lower part illustration of FIG. 3b, cone-shaped radiation element 215 is formed extended longitudinally. Based on this construction of radiation element 215, the horizontal crosspieces in FIG. 3a have degenerated to (vertical) posts 220′. The exemplary embodiment of focusing element 200 shown in FIG. 3c has a radiation element 215 similar to the one in FIG. 3b (also extended longitudinally) which is, however, also developed longitudinally extended in the direction orthogonal to FIG. 3b. Radiation element 215 is also fastened to a hexagonal arrangement of crosspieces 220″ which, in turn, change to clipping devices 210 via vertical crosspieces 220″.

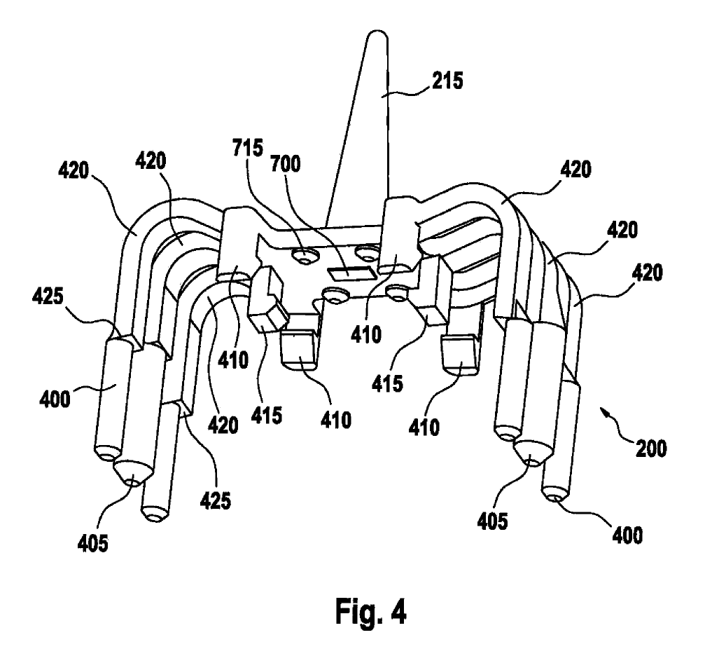

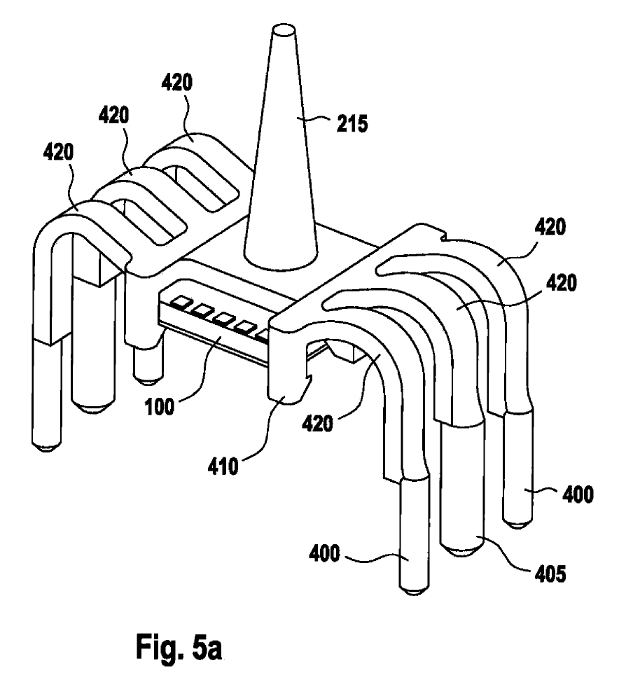

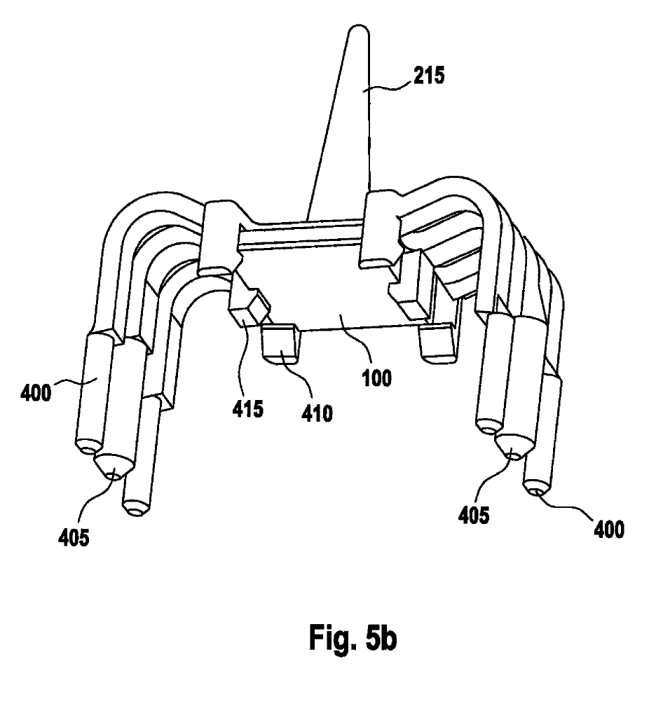

In the present exemplary embodiments focusing element 200 includes crosspieces 220 or 420 mentioned, which branch off outwards in a plane-parallel manner to the surface of HF chip 100. At these crosspieces 220 there is located in each case the relatively small or short post 220′ having positioning devices for the horizontal plane. According to the embodiment variant according to FIGS. 4 through 7, crosspieces 420 are executed as a spring to a fastening device lying outside the HF chip surface (and not shown). The spring is dimensioned so that spacer supports 715 support the lower side of focusing element 200 at a specified short distance, such as 150 μm, from the patch elements on HF chip 100, the longitudinal tolerance chains being intercepted and a lifting due to axial vibrations being prevented. In this context it is also advantageous that conductor surfaces are situated on HF chip 100 below spacer supports 715 which are connected in each case, via through-contacting in HF chip 100, to ground, and which thus prevent harmful electrostatic charging. These grounding conductor surfaces are selected in such a way, in this connection, that in the case of all position tolerances of focusing element 200, the contact surface of spacer supports 715 do not extend beyond these conductor surfaces.

The electrical contacting of HF chip 100 to NF and ZF circuits lying outside takes place via simple bonding connections 500, only low-frequency signals being transmitted besides the d.c. supply voltages, and that being the case, the printed-circuit board can be manufactured of a cost-effective material such as “FR4”.

The fastening of crosspieces 220 of focusing element 200 in the exemplary embodiments named takes place in each case on the same carrier part 110, on which HF chip 100 is also mounted. By contrast to the first exemplary embodiment, in which the carrier part was made of PEI, carrier part 110 in the second and third exemplary embodiment (FIGS. 4-6 and FIG. 7) is made of a good heat-conductive (preferably metallic) material (as in the first exemplary embodiment, for providing a heat sink), such as, for instance, Zn, Al, Mg die casting metal or steel in MIM technology, advantageously using a platform 145 adapted to the chip size.

An otherwise very costly assembly positioning of HF chip 100 is thereby shifted to a very precise and yet inexpensive production of carrier part 110. Chip 100 is adhered or soldered to platform 145. In order to be able to solder on HF chip 100, carrier part 110 is preferably galvanically treated appropriately.

A z positioning and an x/y positioning of the fastening for focusing element 200 are just as cost-effective and have an accurate fit, since manufacturing can be done together with platform 145 on a machine tool. In such an exemplary embodiment, the site positioning takes place using bores which are produced with an accurate fit for the pins of the fastening system. The bores and pins, in this instance, can be designed as press fits or clearance fits. In the first case, the parts are pressed together during assembly, and in the case of the clearance fit they are adhered together by an adhesive. An alternative method of fastening is the one already described, of using clip fasteners for focusing element 200.

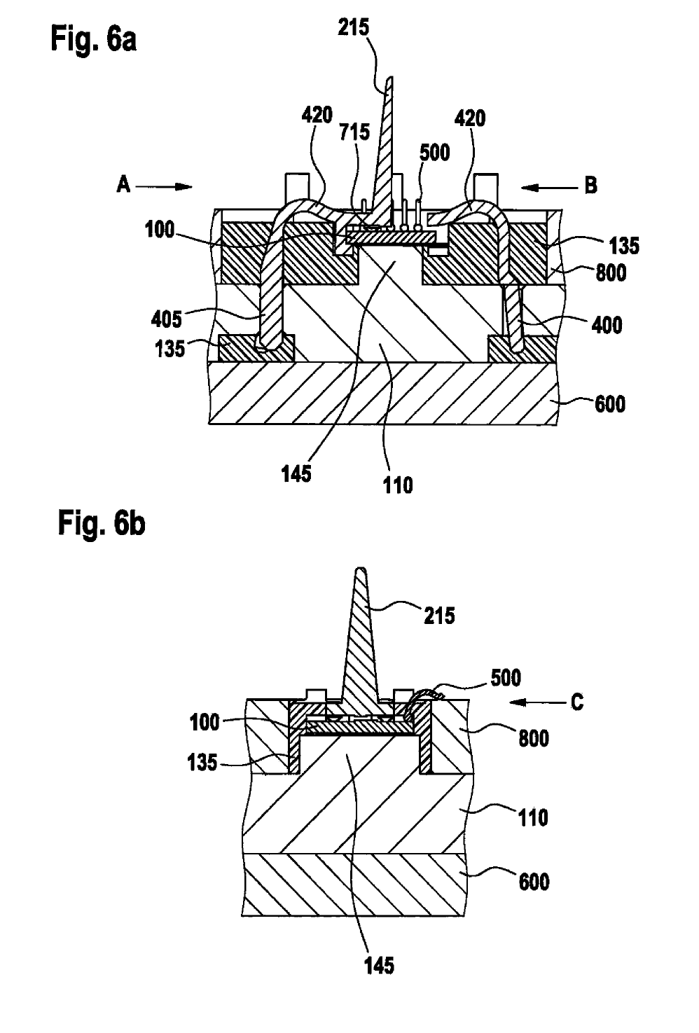

The focusing elements shown in FIGS. 7a-7b correspond to exemplary embodiments of the modular unit according to the present invention, in which HF chip 100 is adhered to, or soldered to carrier part 110, and then the plastic part, along with focusing element 200 (in this instance a rod radiator) is precisely positioned over it onto carrier part 110 and mounted, platform 145 being used in a similar way as in FIG. 6 for the precise positioning of HF chip 100. In the case of a cost-effective Al or Mg die-cast part, in order to achieve an accuracy of a few 10 μm, after the die-cast production, the fastening holes have to be reprocessed in the x and y directions at the platform edge. However, in order to reduce this reprocessing or even to avoid it altogether, the exemplary embodiment of focusing element 200 shown in FIG. 4, in addition to the conventional functional elements, such as spacer pins arranged in the direction towards the surface of HF chip 100, springs, fastening pins 400, 405 or clipping fasteners, shows additional x-y positioning supports 410, 415 for accommodating HF chip 100, by the use of which focusing element 200 can be positioned precisely with respect to the four side surfaces of HF chip 100. The geometry of focusing element 200 is laid out, in this instance, in such a way that the surface required for electrical contacting remains freely accessible via HF chip 100.

In the exemplary embodiments described above, a great mechanical accuracy of the parts, based on the typical frequency range of radar waves, in the range of preferably 77 GHz to 122 GHz, is nevertheless achieved, although the assembly is simpler and more cost-effective compared to the related art. It is also advantageous that the edge reprocessing of platform 145 on carrier part 110 can be omitted.

One can omit altogether a mechanical reprocessing of metallic carrier part 110, for example, if this part advantageously has been produced either using Zn die-cast technology or MIM technology. For, parts made by these two methods already have the required low manufacturing tolerances.

According to the exemplary embodiment shown in FIG. 4, HF chip 100 is first of all adhered into focusing element 200, or is clamped in using positioning supports 410, 415 shown in FIG. 4. Positioning supports 410, 415 mentioned can be designed, in this instance, as clips, at least in one of the two directions (x and y), which then are also used as clamp fasteners. If one does without the clamp fastening, while the site tolerance of HF chip 100 to the resonator is nevertheless sufficiently good, a small quantity of adhesive can be applied at a suitable location on focusing element 200 or on HF chip 100 in order to fasten HF chip 100 in an undetachable manner. Spacer supports 715 are of advantage in this connection, by the use of which, and without any further expenditure, a precise distance of resonator 700 from the antenna element on the surface of HF chip 100 can be achieved.

Positioning pins 405, situated at the respective ends of springs 420, can be designed as clearance fits, so that after assembly, no depth stop comes about between focusing element 200 and carrier part 110. Besides a positioning pin 405, at least one additional pin 400 (“clip pin”) is mounted on a spring 420 that is separate from positioning pin 405. Corresponding counter-holes (“clip holes”), that are not shown, are situated in carrier part 110. In this context, the axes of clip pin 400 and the associated clip hole are positioned offset in such a way that during assembly, clip pins 400 twist with spring 420 and interlock at the relatively sharp-edged lower sides of the clip hole, and, with that, focusing element 200 is securely fastened on carrier part 110.

To simplify the installation of the respective focusing element 200, clip pins 400, positioning pins 405 and the clip holes in the present exemplary embodiment are provided with an appropriate clip stop 425 with respect to one another. The length of clip pins 400 is then selected in such a way that surface 425 positioned towards spring 420 at the end of a clip pin 400 and the surface of carrier part 110 touch. Using these assembly stops, it is ensured that springs 420 cannot be overextended, and that later, upon assembly of the modular unit with carrier part 110, HF chip 100 still rests with its rear side on platform 145 of carrier part 110, which also forms the heat sink. Positioning pins 405 are preferably developed to be of a length that, when clip pins 400 are mounted, they are automatically introduced into the respective clip holes of carrier part 110. One individual positioning pin 405 and/or its spring 420 are designed to be stronger as compared to respective clip pin 400 and its spring 420, so that a decoupling is managed of the positioning function from the clip function.

After complete assembly, carrier part 110 is encapsulated, as was mentioned before. On the rear side of carrier part 110 there is an encapsulating stop 600. In this exemplary embodiment, the adhesive described before, between focusing element 200 and carrier part 110, can be omitted. The stated required mechanical processing of platform 145 as well as positioning pins 405 and the clip holes can also advantageously be performed starting from the same side, that is, without turning carrier part 110. Depending on the manufacturing method of carrier part 110, a mechanical reprocessing can be omitted altogether.

In the embodiment shown in FIG. 4, instead of the above-described at least one clip pin 400, two clip pins 400 are positioned beside each positioning pin 405. This yields a symmetrical force distribution at the focusing element and onto the HF chip.

The HF chip described before has its own antenna configuration, that is, the high-frequency signals delivered by the HF chip are not guided via the bonds mentioned, or the flip-chip technique mentioned, to a distributor network on the printed-circuit board mentioned. Even using costly and time-consuming bonding, increasingly poorer properties would come about, in general, in the named frequency range. Thus, for example, especially designed bonding variants would still just be tolerable at 77 GHz, but would not be possible at all any more at 122 GHz, since the signal is practically completely reflected by the bonding. The printed-circuit board can therefore be produced from the most cost-effective usual material (namely, FR4).

In all the exemplary embodiments, the modular units according to the present invention each have a second resonator patch 700 (visible centrical rectangle in FIGS. 2b, 4, 7a and 7b) situated at a specified distance above HF chip 100, which is applied onto a dielectric substrate such as, for instance, a Kapton foil 730 having a Cu conductor layer. The substrate, in turn, is firmly connected, for example, adhered on its lower side to a suitable carrier part which also includes a focusing element 200. In this context, foil 730 has corresponding positioning holes 740, which correspond to spacer supports 715 of focusing element 200.

Alternatively, second resonator patch can also be situated on the lower side of carrier part 110, or can be applied there. The application of the required thin conductor layers having a thickness of <50 μm onto the plastic injection-molded parts mentioned can be performed using conventional methods, such as the previously mentioned 3D-MID method which, for instance, includes the two methods, the Hot Marker System and the Tampoprint system.

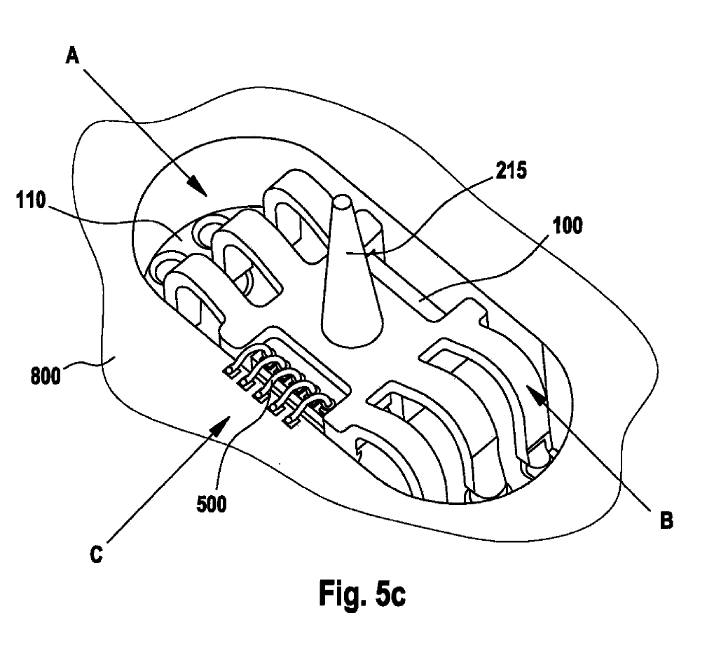

FIGS. 5a-5c show different top views of the exemplary embodiment of focusing element 200 shown in FIG. 4, namely, FIG. 5a shows focusing element 200 having HF chip 100 already inserted slantwise from the top and FIG. 5b slantwise from the bottom. FIG. 5c shows an installed module, focusing element 200 and HF chip 100 in a top view from approximately straight above. In FIG. 5c one may also see the arrangement of bonding contacts 500 of the HF chip to the printed-circuit board. Since HF chip 100 is adhered to carrier part 110, after the insertion or after clamping in on the rear side of HF chip 100, the adhesive mentioned can be applied in such a way that it simultaneously wets positioning supports 410, 415, and consequently it positions HF chip 100 in focusing element 200 in a nondetachable manner. Both HF chip 100 and focusing element 200 are fastened together on carrier part 110, in this exemplary embodiment. The adhesive for HF chip 100 can also alternatively be applied previously onto present metallic platform 145. In the case of fastening using a clearance fit, and the adhesive necessary for this, between focusing element 200 and carrier part 110, the adhesive can be applied before assembly, either on focusing element 200 or carrier part 110. The space filled with air between carrier part 110, focusing element 200, HF chip 100, the feet of bonding contacts 500 on the HF chip up to the plane of the upper edge of printed-circuit board 800 is filled in, using an encapsulating material.

FIGS. 6a and 6b show focusing element 200, shown in FIG. 5c and already mounted on carrier part 110, in two orthogonal sectional views, FIG. 6a representing a layered section along the two sectional axes ‘A’ and ‘B’, which are offset from each other in parallel as shown in FIG. 5c, and FIG. 6b showing a section in sectional axis ‘C’ as shown in FIG. 5c. Reference numeral 110 in both FIGS. 6a and 6b refers to a heat sink, and reference numeral 600 refers to a housing bottom, an additional printed-circuit board or even an extra part having the function of an encapsulating stop. In this illustration, one may see in FIG. 6a especially NF contact pins 500 of HF chip 100 and the lateral curve of springs 420 as well as clip pins 400 and positioning pins 405.

In one assembly step, focusing element 200 is plugged on the upper side of a carrier part 110 shown in FIGS. 6a and 6b, into the correspondingly provided positioning holes, using two positioning pins 405. Thereafter the contacting of HF chip 100 to printed-circuit board 800 takes place via contact pins (bondings) 500. Next, as described above, the space filled with air is filled up with encapsulating compound 135.

Finally, FIGS. 7a and 7b show two exemplary embodiments of focusing element 200, in which a resonator 700 is positioned above an HF chip 100 that has not yet been installed. In the exemplary embodiment according to FIG. 7a, resonator 700, which is located on a separate carrier foil 730, is adhered into focusing element 200. The four spacer supports 715, which define a specified distance from HF chip 100, at the same time form x, y positioning pins for foil 730 and resonator 700, using positioning holes (through holes) 740.

FIG. 7b shows an exemplary embodiment in which resonator 700 is printed directly onto focusing element 200. At the end of two crosspieces 420 that are situated symmetrically to radiation element 215 and are developed as springs, posts 705, 710 are situated which are each composed of a base part 710 having a bore 720 worked in from above and not visible, and a fitted in clip pin or fitting pin 705 injection-molded on from below. The fastening of focusing element 200 into the (not shown) carrier part 110 having mounted HF chip 100 takes place with the aid of aligning pins 705 mentioned, using the bores lying above and the plane surface developed at the upper side of base part 710 as an assembly tool.

Springs 420 have a pure assembly function. Using this ensures that spacer supports 715 lie against the HF chip before the encapsulation. The encapsulating material then embeds the complete unit, and a spring retaining force is no longer required. In FIG. 7b, spring arms 420 are also embedded to a great extent. Because of the embedding, mechanical vibrations are particularly suppressed which would otherwise lead to undesired forces on rod resonator 200 and the surface of HF chip 100.

1-34. (canceled)

35. A modular unit for a radar antenna array, comprising:
an integrated HF chip having at least one antenna element that has a microwave structure;
a focusing element situated in a ray path of the radar antenna array upstream of the at least one antenna element, the focusing element adapted to provide an amplified illumination of the HF chip; and
an addition-to-structure device, using which focusing elements of different antenna characteristics can be mounted onto the modular unit.

36. The modular unit as recited in claim 35, further comprising:
a resonator situated in the ray path of the radar antenna array between the HF chip and the focusing element.

37. The modular unit as recited in claim 36, further comprising:
a resonator carrier for the resonation, wherein at least one of the focusing element and a resonator carrier is made of a dielectric.

38. The modular unit as recited in claim 35, wherein the focusing element is formed by a rod radiator having any desired antenna characteristic.

39. The modular unit as recited in claim 35, wherein the addition-to-structure device is formed by mechanical fasteners, using which at least one of the focusing element and the HF chip is able to be connected detachably to the modular unit.

40. The modular unit as recited in claim 39, wherein the fasteners are formed by one of clamping devices and plug-in devices.

41. The modular unit as recited in claim 40, further comprising:
positioning devices using which the focusing element can be attached to the modular unit with precision.

42. The modular unit as recited in claim 41, wherein the positioning devices are formed by one of clamping devices and plug-in devices.

43. The modular unit as recited in claim 35, wherein the HF chip has flip-chip bumps, using which the HF chip can be installed in the modular unit.

44. The modular unit as recited in claim 35, wherein the modular unit is produced from a 2½-MID-SMT plastic part having a flipped-in HF chip.

45. The modular unit as recited in claim 35, further comprising:
a carrier part made of a heat conductive material, and being made using MID technology (metal injected devices).

46. The modular unit as recited in claim 45, wherein the heat conductive metal is one of Zn, Al or Mg die-cast metal or a metal having low thermal linear extention.

47. The modular unit as recited in claim 35, further comprising:
a platform adapted to a size of the HF chip, as an installation aid when the HF chip is installed.

48. The modular unit as recited in claim 41, wherein at least one of the fasteners and the positioning devices are provided with at least one clip stop.

49. The modular unit as recited in claim 39, wherein the fasteners are each positioned in duplicate in order to assure a symmetrical force distribution at the focusing element and at the HF chip.

50. The modular unit as recited in claim 36, further comprising:
a second resonator situated at a specified distance from the HF chip.

51. The modular unit as recited in claim 50, wherein the second resonator is mounted on a dielectric substrate.

52. The modular unit as recited in claim 51, wherein the dielectric substrate is connected to a dielectric carrier part which also includes a focusing element.

53. The modular unit as recited in claim 52, wherein the second resonator is situated directly on an underside of the dielectric carrier part.

54. The modular unit as recited in claim 53, wherein the dielectric substrate having the second resonator is positioned towards the HF chip by four spacers.

55. The modular unit as recited in claim 35, wherein the focusing element is held by a spring which is embedded in an encapsulating compound.

56. The modular unit as recited in claim 35, wherein all component parts and functional elements of the modular unit are situated in an area-saving and space-saving manner interspersed with one another.

57. A focusing element for use in a modular unit for a radar antenna array, comprising:
an addition-to-structure device, using which the focusing element can be attached to the modular unit.

58. The focusing element as recited in claim 57, wherein the addition-to-structure device is formed by fasteners using which the focusing element can be connected detachably to the modular unit.

59. The focusing element as recited in claim 58, wherein the fasteners are formed by at least one of clamping devices and plug-in devices.

60. The focusing element as recited in claim 58, further comprising:
positioning devices using which the focusing element can be attached to the modular unit with precision.

61. The focusing element as recited in claim 57, wherein the focusing element is produced from a dielectric material.

62. The focusing element as recited in claim _, wherein the focusing element is a rod radiator having any desired antenna characteristic.

63. The focusing element recited in claim 62, wherein different focusing elements differ by a different spatial embodiment of a conic radiation element and a radiator foot.

64. The focusing element as recited in claim 63, wherein the conic element has a longitudinally extending design.

65. A radar antenna array, comprising:
a focusing element having an addition-to-structure device using which the focusing element can be attached to a modular unit.

66. A radar antenna array, comprising:
a modular unit including an integrated HF chip having at least one antenna element that has a microwave structure;
a focusing element situated in a ray path of the radar antenna array upstream of the at least one antenna element, the focusing element adapted to provide an amplified illumination of the HF chip; and
an addition-to-structure device, using which focusing elements of different antenna characteristics can be mounted onto the modular unit.

67. A method for producing a modular unit for a radar antenna array having an integrated HF chip, comprising:
attaching a focusing element to the modular unit using an addition-to-structure device.

68. The method as recited in claim 67, further comprising:
fastening a dielectric carrier part of the modular unit to a front side of a printed-circuit board using at least two positioning pins.

69. The method as recited in claim 68, further comprising:
mounting contact pins and conductor structures on a carrier part which is produced using 2½ mold injected devices.

70. The method as recited in claim 69, further comprising:
manufacturing a resonator together with the conductor structures.
